(19) United States
(12) Patent Application Publication
(10) Pub. No.: US 2026/0069077 A1
(43) Pub. Date: Mar. 12, 2026

(54) Hybrid Coffee Machine with Automatic and Manual Modes

(71) Applicant: STARBUCKS CORPORATION, SEATTLE, WA (US)

(72) Inventors: Jeffrey Jean Chapman, Seattle, WA (US); Kieran A. Murphy, Seattle, WA (US); Jordan David Nieman, Monroe, WA (US)

(73) Assignee: STARBUCKS CORPORATION, SEATTLE, WA (US)

(21) Appl. No.: 19/280,752

(22) Filed: Jul. 25, 2025

Related U.S. Application Data
(60) Provisional application No. 63/693,746, filed on Sep. 12, 2024.

(51) Int. Cl. A47J 31/52; A23F 5/26; A47J 31/36; A47J 31/38; A47J 31/42; A47J 31/46; A47J 31/54

(52) U.S. Cl. CPC A47J 31/52; A23F 5/262; A47J 31/3609; A47J 31/38; A47J 31/42; A47J 31/461; A47J 31/468; A47J 31/54

(57) ABSTRACT

A hybrid coffee machine can include a boiler configured to heat water from a water supply line, a brew group fluidically coupled to the boiler, and a dispensing subsystem fluidically coupled to the brew group. The coffee machine is operable in an automatic mode and in a manual mode. In the automatic mode, coffee grinds are automatically deposited into the brew group and heated water from the boiler is transmitted through the brew group to brew the coffee. The coffee is then dispensed into a receptacle via the dispensing subsystem. In the manual mode, the heated water from the boiler is transmitted through the dispensing subsystem to a portafilter to brew the coffee. The portafilter is removably coupled to the dispensing subsystem.

### CROSS-REFERENCE TO RELATED APPLICATIONS

This claims priority under 35 U.S.C. § 119(e) to U.S. Provisional Patent Application No. 63/693746, filed Sep. 12, 2024 and titled “HYBRID COFFEE MACHINE WITH AUTOMATIC AND MANUAL MODES,” the entirety of which is hereby incorporated by reference herein.

### TECHNICAL FIELD

The present disclosure relates generally to coffee machines. More specifically, but not by way of limitation, this disclosure relates to a hybrid coffee machine that allows for both automatic and manual dispensing of a beverage from the coffee machine.

### BACKGROUND

Coffeehouses often use automatic coffee machines to brew coffee for customers with minimal user intervention. One example of an automatic coffee machine is an automatic espresso machine, which is designed to alleviate many of the tasks required for pulling espresso shots such as dose management, grinding, and manual tamping. Coffeehouses may also have manual coffee machines, which are particularly favored by coffee enthusiast who appreciate the hands-on approach and control it offers over the brewing process. One example of a manual coffee machine is a manual espresso machine, which may require manual grinding, dosing, and tamping. These two types of machines normally cater to different preferences and operational needs.

### BRIEF DESCRIPTION OF THE DRAWINGS

FIG. 1 shows a block diagram of an example of a hybrid coffee machine in an automatic mode according to some aspects of the present disclosure.

FIG. 2 shows a block diagram of an example of a hybrid coffee machine that includes a bypass valve and is operating in a manual mode, according to some aspects of the present disclosure.

FIG. 3 shows a block diagram of an example of a hybrid coffee machine that excludes a bypass valve, according to some aspects of the present disclosure.

FIG. 4 shows a block diagram of an example of a hybrid coffee machine with multiple brew groups, according to some aspects of the present disclosure.

FIG. 5 shows a block diagram of an example of control system for a hybrid coffee machine, according to some aspects of the present disclosure.

FIG. 6 shows a flowchart of an example of a process performed during an automatic brewing mode of a hybrid coffee machine, according to some aspects of the present disclosure.

FIG. 7 shows a flowchart of an example of a process performed during a manual brewing mode of a hybrid coffee machine, according to some aspects of the present disclosure.

FIGS. 8A-B show an example of a mechanical control system according to some aspects of the present disclosure.

### DETAILED DESCRIPTION

Certain aspects and features of the present disclosure relate to a hybrid coffee machine that can be switched between manual and automatic modes of brewing coffee, such as espresso. Both the manual and automatic modes can share many of the same physical components, such as the water line, high-pressure pump, power supply, electronic controls, boiler, drip tray, and drain system. In some examples, the hybrid coffee machine may also have a shared dispenser for both automatic extraction and manual extraction. Because the hybrid machine has a smaller footprint than two separate machines and removes the need for duplicates of the shared components, it can reduce the cost of fabrication, installation, and maintenance.

In some examples, the hybrid coffee machine can include a single brew group (e.g., extraction cell) used for both modes of operation. The brew group can be a metal component internal to the coffee machine. In the automatic mode, coffee grounds can be automatically dosed and tamped in the brew group. Heated water from the internal boiler can then be passed over the coffee grounds in the brew group to brew the coffee. From the brew group, the coffee can be transmitted to a dispenser, such as a group head which can dispense the coffee into a receptacle such as a cup or carafe. Thus, in the automatic mode, the brewing process occurs in the brew group, which is internal to the housing of the coffee machine. In the manual mode, a portafilter with manually dosed and tamped coffee grounds can be removably coupled to the dispenser. Heated water from the internal boiler can then be passed through the brew group and out the dispenser. From the dispenser, the heated water can pass through the portafilter to brew the coffee. Thus, in the manual mode, the brewing process occurs outside the brew group and in the portafilter, which is external to the housing of the coffee machine.

In some examples, the same dispenser can be used for both the automatic and manual modes. For instance, the same group head can be used in both modes. This group head can be a hybrid group head, which is physically designed to for use in both modes. For example, the hybrid group head can include an attachment mechanism for coupling with a portafilter in the manual mode and decoupling from a portafilter in the automatic mode. By using the same dispenser for both modes, the size and cost of the coffee machine can be reduced.

Alternatively, the hybrid coffee machine may have separate dispensers for automatic mode and manual mode, but may still share the same brew group. For instance, the hybrid coffee machine may have a first group head for use in the automatic mode and a second group head (e.g., designed to couple with a portafilter) for use in the manual mode. The brew group can be fluidically coupled to both such dispensers. In the automatic mode, coffee grounds can be automatically dosed and tamped in the brew group. Heated water from the internal boiler can then be passed through the brew group, over the coffee grounds, and to the first dispenser (e.g., first group head) to dispense the coffee. In the manual mode, a portafilter with manually dosed and tamped coffee grounds can be removably coupled to the second dispenser (e.g., second group head), which is physically separate from the first dispenser. Heated water from the internal boiler can then be passed through the brew group, out the second dispenser, and through the portafilter to brew the coffee. By having two separate dispensers on a single machine, contamination may be reduced.

In some examples, the brew group can be bypassed altogether in the manual mode. For instance, upon entering the manual mode, the hybrid coffee machine can activate a bypass valve that fluidically couples the internal boiler to a dispenser via a conduit system. The conduit system can exclude the brew group. The heated water can then be passed through the conduit system to the dispenser, without entering the brew group, and finally through the portafilter to brew the coffee.

In some examples, the hybrid coffee machine can include a sensor that is configured to detect whether a portafilter is attached. For instance, the portafilter can include a metal contact that completes a circuit when the portafilter is attached to the hybrid coffee machine. If the user tries to initiate the manual mode while a portafilter is not attached, the hybrid coffee machine can detect that the portafilter is not attached and responsively may prevent execution of the manual mode. This may be a safety feature to prevent the dispensing of hot water when a portafilter is not attached to the hybrid coffee machine.

By incorporating automatic and manual extraction capabilities into a single coffee machine, the hybrid coffee machine can create a wider variety of coffee beverages than may otherwise be possible using a conventional coffee machine. For example, the brew group and the portafilter of the hybrid coffee machine can be designed for different sizes and brewing capabilities (e.g., thermal retention characteristics, screen mesh, doses, etc.). This can enable users to prepare a broader range of coffee types and sizes, enhancing versatility.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

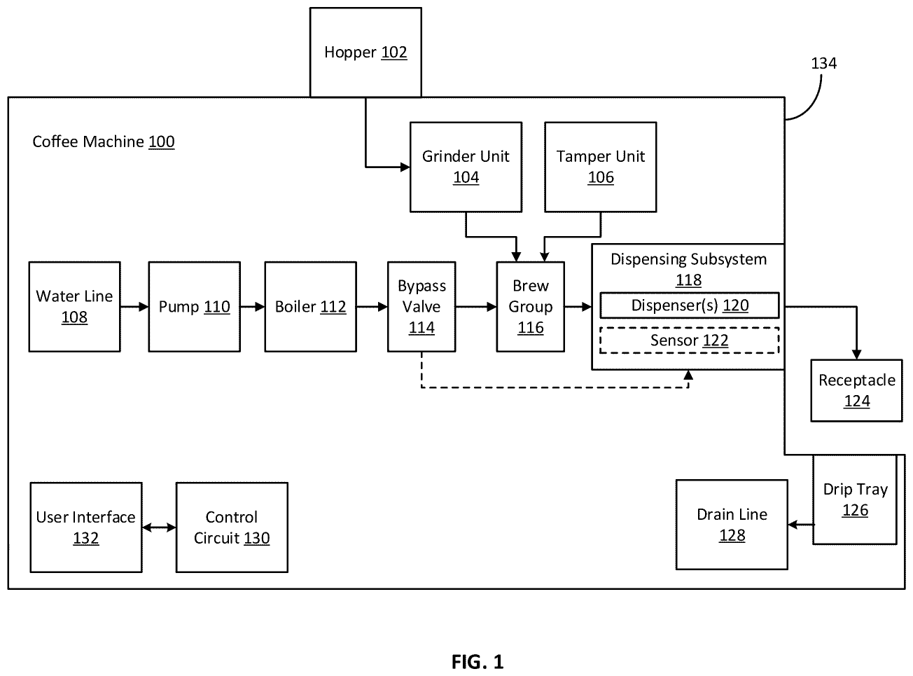

FIG. 1 shows a block diagram of an example of a hybrid coffee machine 100 in an automatic mode according to some aspects of the present disclosure. The hybrid coffee machine 100 can includes a water line 108 configured to be attached to a water source. The water line 108 can be fluidically coupled (e.g., by one or more conduits) to a pump 110. The pump 110 can be configured to pump water from the water source to a boiler 112, which can heat the water to a desired temperature for brewing coffee. For example, the boiler 112 can heat the water to 195° F-205° F.

The coffee machine 100 can also include a bypass valve 114 fluidically coupled between the boiler 112 and a brew group 116. When the coffee machine 100 is in the automatic mode, the bypass valve 114 can be disabled. When disabled, the bypass valve 114 can allow water to flow from the boiler 112 to the brew group 116.

The brew group 116 can be coupled to a grinder unit 104. The grinder unit 104 can grind coffee beans in a hopper 102 of the coffee machine 100 and dispense the coffee grinds into the brew group 116. The grinder unit 104 can include a grinding chamber housing a grinder device which may include a set of rotary blades/burrs. The grinding device is coupled to a drive shaft connected to an electric motor, which can control the rotation speed. The grinder unit 104 can include a ground coffee outlet positioned beneath the grinding device, through which the ground particles are discharged into a collection chute or directly into the brew group 116. The grinder unit 104 may include sensors to monitor bean level in the hopper, detect clogging or jamming, and verify particle size.

The brew group 116 can also be coupled to a tamper unit 106. The tamper unit 106 can tamp the coffee grinds in the brew group 116 to ready them for brewing. The tamper unit 106 can include a movable tamping element such as a piston or plunger, which is aligned with the axis of the extraction cell. The tamping element is actuated by an actuation assembly, which may include an electric motor, linear actuator, or pneumatic cylinder. The force applied by the tamping element can be precisely regulated and may be measured by a force sensor or load cell integrated into the actuator assembly. The tamping element can apply a defined tamping force to compact the coffee grounds within the brew group 116 and ensure uniform water permeation during extraction. The tamper unit 106 may further include guide rails, bushings, or sleeves to maintain proper alignment of the tamping element and prevent tilting or misapplication of force.

In the automatic mode, the coffee machine 100 can operate the grinder unit 104 to create an appropriate dose of coffee grinds and dispense them into the brew group 116. The coffee machine 100 can then operate the tamper unit 106 to tamp the coffee grinds in the brew group 116. Once the coffee grinds have been sufficiently tamped, the coffee machine 100 can pump the heated water from the boiler 112 through the bypass valve 114 and into the brew group 116. The heated water can pass through the tamped coffee grinds to brew the coffee. The coffee can then be transferred to a dispensing subsystem 118 for dispensing to a receptacle 124, such as a cup or container. The dispensing subsystem 118 can include one or more dispensers (e.g., nozzles or spouts) for dispensing the coffee into the receptacle 124. Extraneous fluid may be captured by a drip tray 126 and disposed of via a drain line 128.

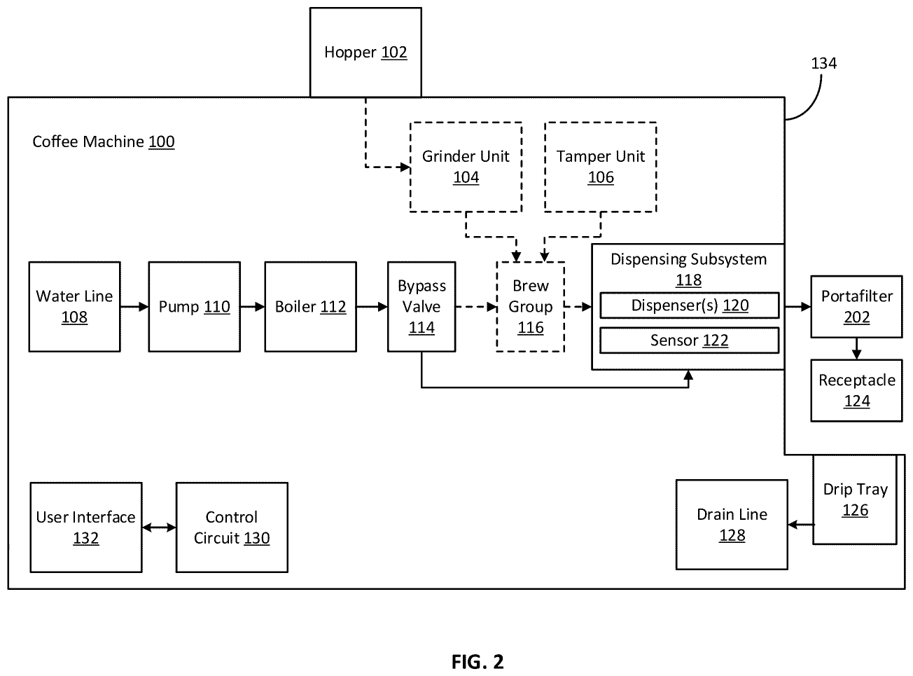

Various components can be located at least partially within the outer housing 134 of the coffee machine 100. For example, the hopper 102, grinder unit 104, tamper unit 106, water line 108, pump 110, boiler 112, bypass valve 114, brew group 116, drip tray 126, drain line 128, dispensing subsystem 118, and/or control circuit 130 can be partially or entirely within the outer housing 134. Conversely, the receptacle 124 for receiving the coffee may be external to the outer housing 134 of the coffee machine 100. The coffee machine 100 can also have other components that may be unused or disabled in the automatic mode. Those components are represented by dashed lines in FIG. 2.

In addition to the automatic mode, the coffee machine 100 can operate in a manual mode, which is shown in FIG. 2. Referring now to FIG. 2, in the manual mode, the coffee machine 100 may enable the bypass valve 114 to direct the heated water from the boiler 112 around the brew group 116 to the dispensing subsystem 118. Because the brew group 116 is bypassed, no coffee is brewed in the brew group 116. Since no coffee is brewed in the brew group 116, the grinder unit 104 and/or the tamper unit 106 can be disabled. The brew group 116 may also be empty of coffee grinds. This is represented by the dashed lines in FIG. 2, which indicate components that may be bypassed or disabled in the manual mode. In this arrangement, the heated water flows directly from the bypass valve 114 to the dispensing subsystem 118, where it is dispensed from one or more dispensers 120 (e.g., group heads) to a portafilter 202 that is removably coupled to the dispensing subsystem 118. The heated water can be transferred through tamped coffee grinds in the portafilter 202 to brew the coffee, which is ultimately dispensed into the receptacle 124. Extraneous fluid may be captured by a drip tray 126 and disposed of via a drain line 128.

In some examples, the dispensing subsystem 118 may contain a single dispenser that is shared for both the automatic and manual modes. In this arrangement, the brew group 116 and the bypass valve 114 can both be fluidically coupled to the same dispenser. This may reduce the number of parts in the coffee machine 100, lowering costs and simplifying maintenance. Alternatively, the dispensing subsystem 118 can include at least two dispensers-a first dispenser for the automatic mode and a second dispenser for the manual mode. In this arrangement, the brew group 116 can be fluidically coupled to the first dispenser and the bypass valve 114 can be fluidically coupled to the second dispenser. Using two separate dispensers, rather than a single shared dispenser for both modes, may prevent contamination.

In some examples, the coffee machine 100 can include a sensor 122 for detecting whether the portafilter 202 is attached to the dispensing subsystem 118. The sensor 122 may be located on the dispensing subsystem 118. Examples of the sensor 122 may include a metal contact, a button, or a switch. If the sensor 122 is a metal contact, there may be a corresponding metal contact on the portafilter 202 that completes a circuit when the portafilter 202 is attached. If the sensor 122 is a button, it may be configured to be depressed when the portafilter 202 is attached. If the sensor 122 is a switch, it may be configured to be flipped when the portafilter 202 is attached. The sensor 122 can transmit signals to the control circuit 130, which can determine based on those signals whether the portafilter 202 is attached to the dispensing subsystem 118. If not, the control circuit 130 may prevent execution of the manual mode. This may serve as a safety precaution so that heated water is not dispensed from the coffee machine 100 before the user is ready.

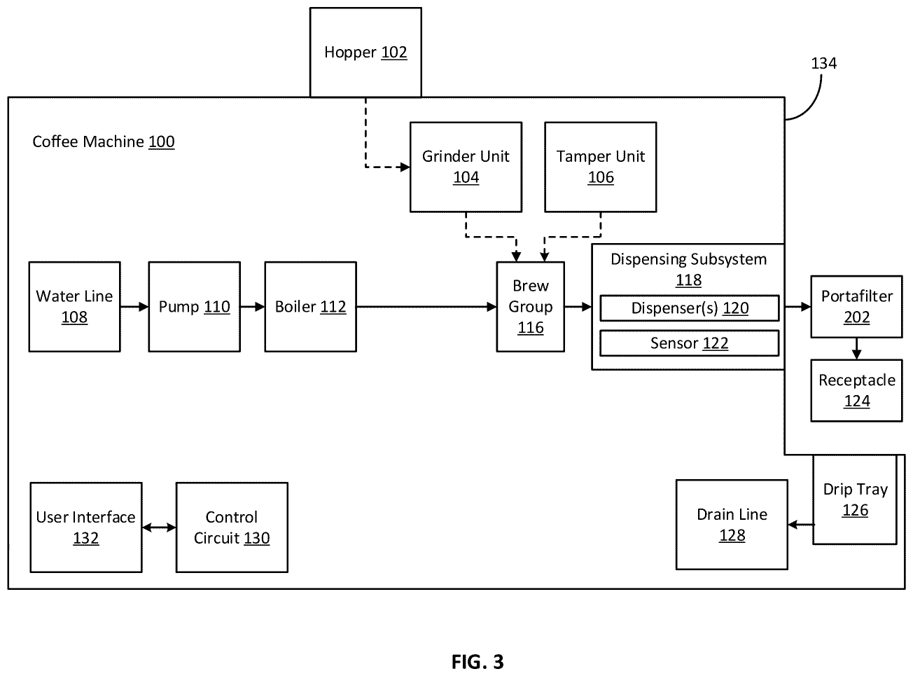

Referring now to FIG. 3, some examples may exclude the bypass valve. In those examples, the heated water may be pumped from the boiler 112 to the brew group 116 in both the automatic and manual modes. More specifically, in the automatic mode, the coffee machine 100 may function as described above with respect to FIG. 1. In the manual mode, the coffee machine 100 may pump the heated water from the boiler 112 through the brew group 116 to the dispensing subsystem 118. Because the heated water is passed through the brew group 116, the brew group 116 may be emptied of coffee grounds beforehand. The grinder unit 104 and/or the tamper unit 106 may also be disabled during the manual mode. This is represented by the dashed lines in FIG. 3, which indicate components that may be disabled during the manual mode.

To engage the automatic mode or the manual mode, a user can interact with a user interface 132. The user interface 132 can include physical buttons, knobs, sliders, or any combination of these. Additionally or alternatively, the user interface 132 can include virtual buttons, knobs, sliders, or any combination of these, which may be output on a display such as a touch-screen display. The user interface 132 can be electrically coupled to a control circuit 130, which is configured to facilitate the operation of the coffee machine 100. As will be described in greater detail later, the control circuit 130 can be electrically coupled to the various other components of the coffee machine 100 (e.g., grinder unit 104, tamper unit 106, pump 110, boiler 112, bypass valve 114, etc.) to facilitate their operation in the automatic and manual modes.

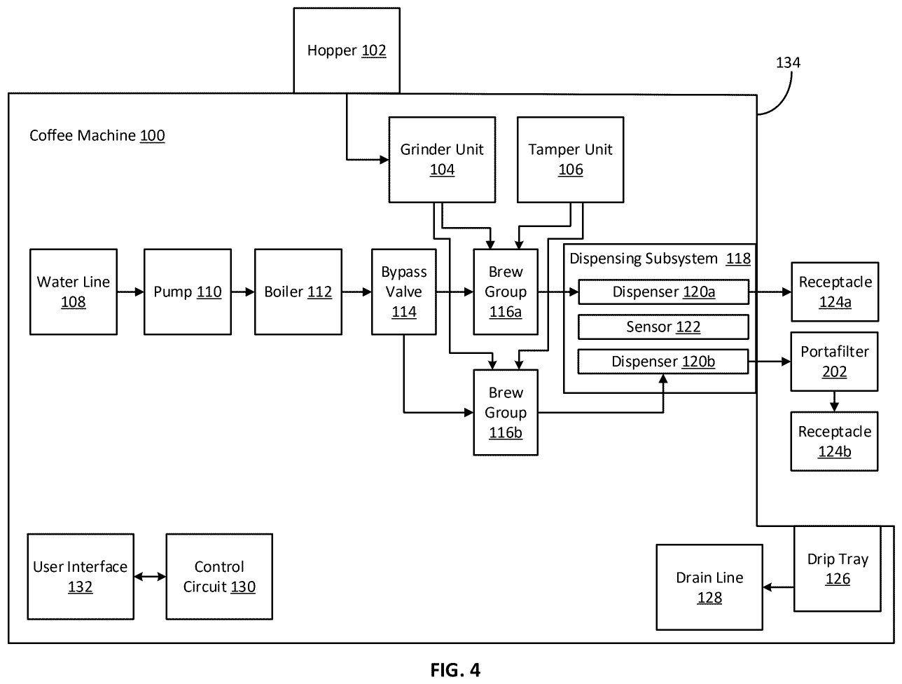

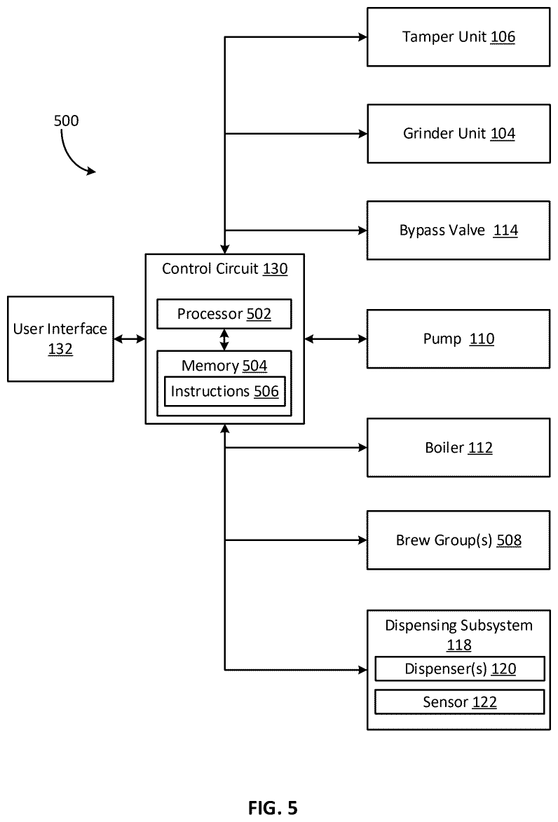

Turning now to FIG. 4, some examples may involve multiple brew groups 116a-b. In this arrangement, the bypass valve 114 may be fluidically coupled to all the brew groups 116a-b. The bypass valve 114 can direct heated water to one brew group at a time. For example, the bypass valve 114 can direct heated water to the first brew group 116a and not the second brew group 116b, or to the second brew group 116b and not the first brew group 116a. Additionally or alternatively, the bypass valve 114 can direct heated water to multiple brew groups in parallel. For example, the bypass valve 114 can direct a first portion of the heated water from the boiler to the first brew group 116a and a second portion of the heated water from the boiler to the second brew group 116b, so that both brew groups 116a-b can be used at the same time (e.g., in parallel).

Each of the brew groups 116a-b may be used as described above for automatic brewing and/or manual brewing. For automatic brewing, each of the brew groups 116a-b may all be coupled to the grinder unit 104 and/or tamper unit 106.

The brew groups 116a-b may be operated sequentially or in parallel, using the same or different brewing modes. For example, two shots of espresso can be brewed in parallel using the brew groups 116a-b. In one such example, the coffee machine 100 may operate in the automatic mode with respect to brew group 116a to dispense a first shot of espresso via dispenser 120a. At the same time, the coffee machine 100 may operate in the manual mode with respect to the brew group 116b to dispense heated water via dispenser 120b, so that a second shot of espresso can be brewed in the portafilter 202. Thus, two different brewing modes can be performed at the same time using a single coffee machine 100.

Although only two brew groups 116a-b are shown in FIG. 4 for simplicity, it will be appreciated that additional brew groups may be included in other examples. Thus, the present disclosure is not intended to be limited to only two brew groups in a single coffee machine.

Turning now to FIG. 5, shown is a block diagram of an example of control system 500 for a hybrid coffee machine, according to some aspects of the present disclosure. As shown, the control system 500 can include a control circuit 130 coupled (e.g., communicatively coupled) to a user interface 132. The control circuit 130 can also be coupled to the tamper unit 106, the grinder unit 104, the bypass valve 114, the pump 110, the boiler 112, one or more brew groups 508 (e.g., brew groups 116a-b), a dispensing subsystem 118 with one or more dispensers 120, and/or a sensor 122. By transmitting the appropriate control signals, the control circuit 130 can activate and/or deactivate any of the aforementioned components to implement the automatic and manual modes described above.

In some examples, the control circuit 130 can include a processor 502 coupled to memory 504. The processor 502 can include one processor or multiple processors. Examples of the processor 502 include a Field-Programmable Gate Array (FPGA), an application-specific integrated circuit (ASIC), or a microprocessor. The processor 502 can execute instructions 506 stored in the memory 504 to perform one or more operations. In some examples, the instructions 506 can include processor-specific instructions generated by a compiler or an interpreter from code written in any suitable computer-programming language, such as C, C++, C #, and Java.

The memory 504 can include one memory device or multiple memory devices. The memory 504 can be volatile or non-volatile, in that the memory 504 can retain stored information when powered off. Examples of the memory 504 include electrically erasable and programmable read-only memory (EEPROM), flash memory, or any other type of non-volatile memory. At least a portion of the memory device includes a non-transitory computer-readable medium. A computer-readable medium can include electronic, optical, magnetic, or other storage devices capable of providing the processor 502 with the instructions 506 or other program code. Non-limiting examples of a computer-readable medium include magnetic disks, memory chips, ROM, random-access memory (RAM), an ASIC, a configured processor, optical storage, or any other medium from which a computer processor can read the instructions 506.

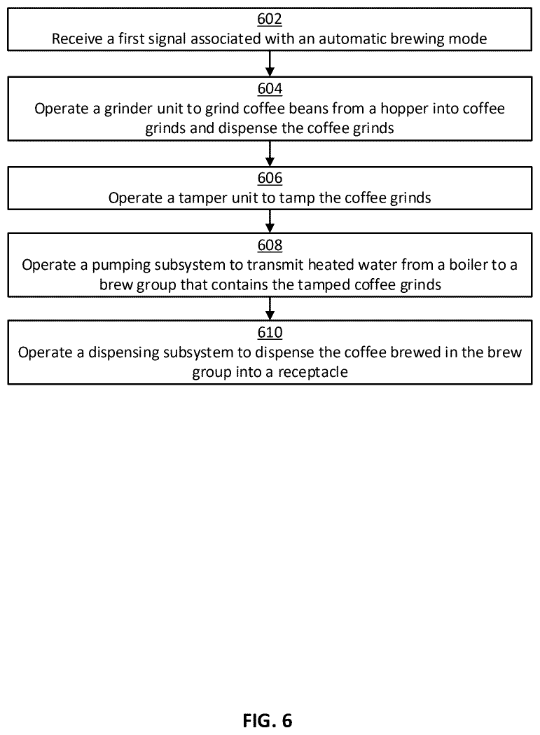

Turning now to FIG. 6, shown is a flowchart of an example of a process performed during an automatic brewing mode of a hybrid coffee machine, according to some aspects of the present disclosure. Other examples may involve more operations, fewer operations, different operations, or a different sequence of operations than is shown. The operations of FIG. 6 are described below with reference to the components of FIGS. 1-5 described above.

In block 602, a control circuit 130 of a coffee machine 100 receives a first signal associated with an automatic brewing mode. The first signal can be for initiating the automatic brewing mode, for instance to create a single-serving coffee for a customer. The control circuit 130 may receive the first signal from the user interface 132. The first signal can be generated by the user interface 132 in response to a user selecting a button to initiate the automatic brewing mode.

In block 604, the control circuit 130 operates a grinder unit 104 to grind coffee beans from a hopper 102 into coffee grinds and dispense the coffee grinds. The coffee grinds may be dispensed into a brew group 116. The control circuit 130 can operate the grinder unit 104 by transmitting a first control signal to the grinder unit 104.

In block 606, the control circuit 130 operates a tamper unit 106 to tamp the coffee grinds. The coffee grinds may be tamped while inside the brew group 116. The control circuit 130 can operate the tamper unit 106 by transmitting a second control signal to the tamper unit 106.

In block 608, the control circuit 130 operates a pumping subsystem (e.g., pump 110) to transmit heated water from a boiler 112 to a brew group 116, which contains the tamped coffee grinds. The control circuit 130 can operate the pumping subsystem by transmitting a third control signal to the pumping subsystem. Transferring the heated water through the tamped coffee grinds can produce coffee.

In block 610, the control circuit 130 operates a dispensing subsystem (e.g., dispenser 120) to dispense the coffee brewed in the brew group into a receptacle 124, which may be positioned underneath the dispenser 120 of the coffee machine 100. The control circuit 130 can operate the dispensing subsystem by transmitting a fourth control signal to the dispensing subsystem.

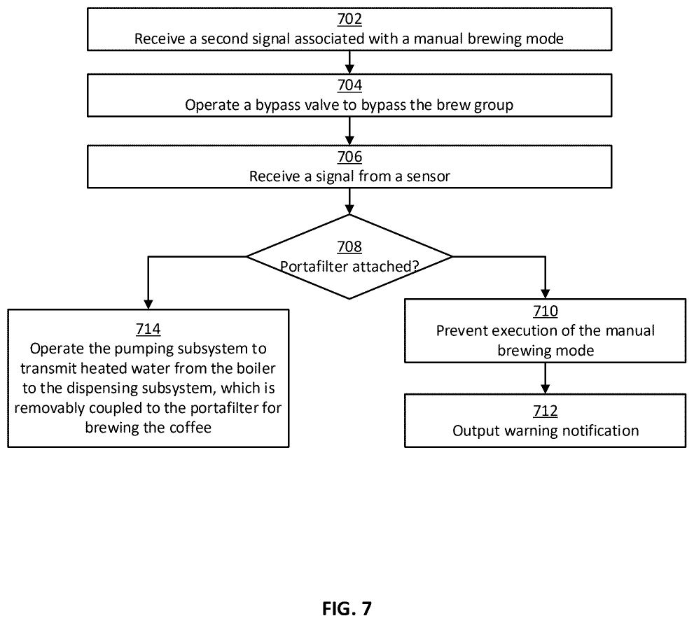

Turning now to FIG. 7, shown is a flowchart of an example of a process performed during a manual brewing mode of a hybrid coffee machine, according to some aspects of the present disclosure. Other examples may involve more operations, fewer operations, different operations, or a different sequence of operations than is shown. The operations of FIG. 7 are described below with reference to the components of FIGS. 1-5 described above.

In block 702, the control circuit 130 of the coffee machine 100 receives a second signal associated with a manual brewing mode. The second signal can be for initiating the manual brewing mode. The control circuit 130 may receive the second signal from the user interface 132. The second signal can be generated by the user interface 132 in response to a user selecting a button to initiate the manual brewing mode.

In block 704, the control circuit 130 operates a bypass valve 114 to bypass the brew group 116. For instance, the control circuit 130 can transmit a control signal to enable the bypass valve 114. This can establish a fluidic connection between the boiler 112 and the dispensing subsystem 118 that bypasses the brew group 116.

In block 706, the control circuit 130 receives a signal from a sensor 122 for determining whether a portafilter 202 is coupled to the dispensing subsystem 118.

In block 708, the control circuit 130 determines whether a portafilter 202 is coupled to the dispensing subsystem 118 based on the signal from the sensor 122. If not, the process can proceed to block 710, where the control circuit 130 prevents execution of the manual brewing mode. The control circuit 130 may also output a warning notification to the user (in block 712). For example, the control circuit 130 may instruct the user interface 132 to output the warning notification. The warning notification may include an auditory notification and/or a visual notification. The control circuit 130 may prevent execution of the manual brewing mode until it detects that the portafilter 202 is attached.

On the other hand, if the control circuit 130 determines that the portafilter 202 is coupled to the dispensing subsystem 118, the process can proceed to block 714 where the control circuit 130 can execute the manual brewing mode. In particular, the control circuit 130 can operate the pumping subsystem to transmit the heated water from the boiler 112 to the dispensing subsystem 118. With the bypass valve 114 enabled, the heated water may bypass the brew group 116. In other examples that exclude the bypass valve 114, the heated water may travel through the brew group 116 to the dispensing subsystem 118. Either way, the heated water can be pumped to the dispensing subsystem 118 and dispensed into a portafilter 202, without any coffee being brewed internally to the brew group 116 (or elsewhere in the coffee machine). The portafilter 202 can be removably coupled to the dispensing subsystem 118 for receiving the heated water and brewing the coffee.

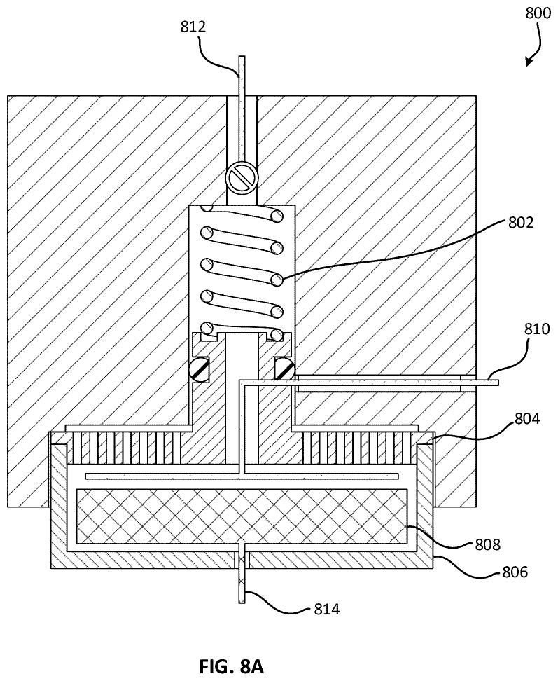

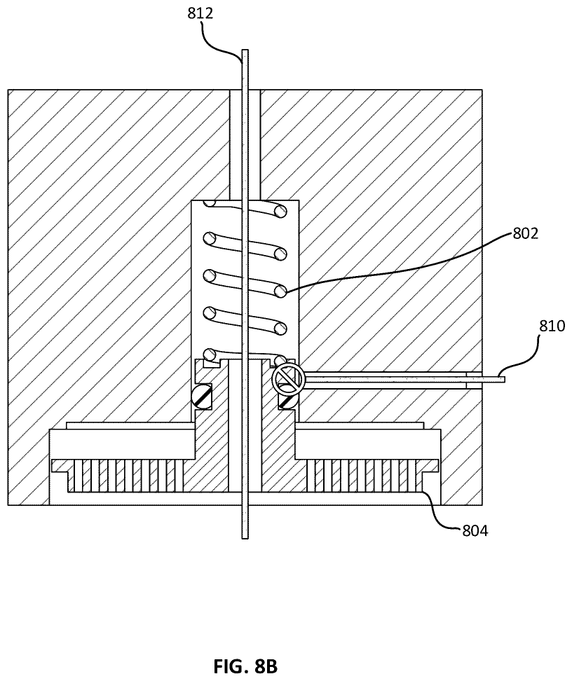

Many of the above examples involve using a software control system to switch between the manual mode and the automatic mode, but it will be appreciated that other implementations are possible. For instance, some implementations may include a mechanical control system 800 that is more mechanically driven. One such example of shown in FIGS. 8A-B. With the mechanical control system 800, the manual mode can be triggered and operated via a spring mechanism 802. Referring now to FIG. 8A, as the portafilter 806 is inserted into the group head, it can push up a shower/dispersion screen 804 of the group head in such a way that a valve (e.g., bypass valve 114) is activated, allowing for water to flow through a first flow path 810 from the boiler 112 through the screen 804 to the portafilter 806. This first flow path 810 may exclude the internal brew group, depending on how the valve is fluidically arranged within the machine. As water flows through the first flow path 810 and the portafilter 806, it can interact with a coffee puck 808 to produce a coffee beverage 814. Pushing up on the screen 804 can also compress a corresponding spring 802 or set of springs, which may operate a valve to cut off a second flow path 812. Referring now to FIG. 8B, when the portafilter 806 is removed, the spring(s) 802 can decompress such that the screen 804 is returned to its original position and the valve is deactivated. This can block the first flow path 810 through the screen 804 and only allow fluid to flow through the second flow path 812 from the automatic portions of the machine. Through this mechanical process, the machine can be switched between the manual and automatic modes by physically attaching and detaching the portafilter 806, respectively. In some examples, this mechanical process may be combined with one or more of the features and/or techniques described above, which can improve redundancy or safety. For instance, this mechanical process can be used to control the bypass valve 114 of FIGS. 1-5, while the control circuit 130 is used to control the pump 110, boiler 112, brew groups 508, grinder unit 104, and/or tamper unit 106 of FIGS. 1-5. This combined control system may provide improved safety over either approach individually.

While the above examples are described with respect to a coffee machine for brewing coffee, similar principles could be applied to other kinds of beverage machines for brewing other kinds of beverages. For example, similar principles could be applied to a tea machine. In that example, the tea machine may have similar components to the coffee machine described above (e.g., a water line, pimp, boiler, brew group, etc.) and may be operable in automatic and manual modes for brewing tea. In the automatic mode, the tea machine may brew the tea internally to its outer housing and then dispense the tea into a receptacle, which is outside the tea machine. In the manual mode, the tea machine may dispense the heated water into the receptacle outside the tea machine, without brewing any tea. Rather, the receptacle can include the tea leaves. The introduction of the heated water into the receptacle can brew the tea.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A coffee machine, comprising:
a boiler configured to heat water from a water supply line;
a brew group fluidically coupled to the boiler; and
a dispensing subsystem fluidically coupled to the brew group;
wherein the coffee machine is operable in an automatic mode in which coffee grinds are automatically deposited into the brew group and heated water from the boiler is transmitted through the brew group to brew coffee therein before being dispensed into a receptacle via the dispensing subsystem, and wherein the coffee machine is operable in a manual mode in which the heated water from the boiler is transmitted through the dispensing subsystem to a portafilter to brew coffee therein, the portafilter being removably coupled to the dispensing subsystem.

2. The coffee machine of claim 1, wherein the dispensing subsystem includes a single dispenser that is shared for both the automatic and manual modes.

3. The coffee machine of claim 2, wherein the coffee machine is configured to transmit the heated water through the brew group to the single dispenser in both the automatic and manual modes.

4. The coffee machine of claim 1, wherein the dispensing subsystem includes a first dispenser for the automatic mode and a second dispenser for the manual mode.

5. The coffee machine of claim 4, wherein the coffee machine is configured to transmit the heated water through the brew group to the first dispenser in the automatic mode and the second dispenser in the manual mode.

6. The coffee machine of claim 1, further comprising a bypass valve operable to bypass the brew group, wherein the coffee machine is configured to operate the bypass valve in the manual mode to bypass the brew group when transmitting the heated water from the boiler to the dispensing subsystem.

7. The coffee machine of claim 1, wherein the coffee machine is configured to detect whether the portafilter is coupled to the dispensing subsystem using a sensor and, in response to detecting that the portafilter is not attached to the dispensing subsystem, prevent execution of the manual mode.

8. A method implemented by a coffee machine, the method comprising:
executing an automatic mode in which coffee grinds are automatically deposited into a brew group and heated water from a boiler is transmitted to the brew group for brewing coffee, which is then dispensed from the brew group into a receptacle via a dispensing subsystem; and
executing a manual mode in which the heated water from the boiler is transmitted through the dispensing subsystem to a portafilter for brewing the coffee, which is then dispensed from the portafilter into the receptacle, the portafilter being removably coupled to the dispensing subsystem.

9. The method of claim 8, wherein the dispensing subsystem includes a single dispenser that is shared for both the automatic and manual modes.

10. The method of claim 9, wherein the coffee machine transmits the heated water through the brew group to the single dispenser in both the automatic and manual modes.

11. The method of claim 8, wherein the dispensing subsystem includes a first dispenser for the automatic mode and a second dispenser for the manual mode.

12. The method of claim 11, wherein the coffee machine transmits the heated water through the brew group to the first dispenser in the automatic mode and the second dispenser in the manual mode.

13. The method of claim 8, further comprising:
operating, by the coffee machine in the manual mode, a bypass valve to bypass the brew group when transmitting the heated water from the boiler to the dispensing subsystem.

14. The method of claim 8, further comprising:
detecting whether the portafilter is coupled to the dispensing subsystem using a sensor; and
in response to detecting that the portafilter is not attached to the dispensing subsystem, preventing execution of the manual mode.

15. The method of claim 8, wherein the brew group is empty of coffee grinds when the coffee machine is operating in the manual mode.

16. A coffee machine, comprising:
a pumping subsystem;
a boiler fluidically coupled to the pumping subsystem, wherein the boiler is configured to heat water from a water supply line;
a brew group fluidically coupled to the boiler;
a dispensing subsystem fluidically coupled to the brew group;
a hopper for storing coffee beans;
a grinder unit for grinding the coffee beans into coffee grinds;
a tamper unit for tamping the coffee grinds; and
a control circuit configured to:
receive a first signal associated with an automatic mode;
in response to receiving the first signal:
operate the grinder unit to automatically grind the coffee beans in the hopper into the coffee grinds and dispense the coffee grinds into the brew group;
operate the tamper unit to automatically tamp the coffee grinds in the brew group;
operate the pumping subsystem to transmit heated water from the boiler to the brew group; and
operate the dispensing subsystem to dispense coffee brewed in the brew group using the heated water and the coffee grinds into a receptacle; and
receive a second signal associated with a manual mode; and
in response to receiving the second signal, operate the pumping subsystem to transmit the heated water from the boiler to the dispensing subsystem, wherein the dispensing subsystem is configured to removably couple with a portafilter that contains the coffee grinds for brewing the coffee.

17. The coffee machine of claim 16, wherein the control circuit is configured not to operate the grinder unit and/or the tamper unit in response to receiving the second signal.

18. The coffee machine of claim 16, wherein the pumping subsystem includes a bypass valve operable to bypass the brew group when the heated water is being transmitted from the boiler to the dispensing subsystem, and wherein the control circuit is configured to activate the bypass valve in response to receiving the second signal.

19. The coffee machine of claim 16, wherein the control circuit is configured to receive the first signal in response to a first user interaction with a user interface of the coffee machine, and wherein the control circuit is configured to receive the second signal in response to a second user interaction with the user interface of the coffee machine.

20. The coffee machine of claim 16, wherein the control circuit is configured to:
receive a signal from a sensor;
detect whether the portafilter is attached to the dispensing subsystem based on the signal; and
in response to determining that the portafilter is not attached to the dispensing subsystem, prevent execution of the manual brewing mode and transmit a notification to a user of the coffee machine.

21. The coffee machine of claim 1, further comprising:
a hopper including coffee beans;
a grinder unit for grinding the coffee beans into the coffee grinds; and
a tamper unit for tamping the coffee grinds;
wherein the coffee machine is further configured to:
operate the grinder unit to automatically grind the coffee beans into the coffee grinds and dispense the coffee grinds into the brew group; and
operate the tamper unit to automatically tamp the coffee grinds in the brew group.

22. The method of claim 8, wherein the boiler is configured to heat water from a water supply line, and further comprising:
storing coffee beans in a hopper;
operating a grinder unit to automatically grind the coffee beans into coffee grinds; and
operating a tamper unit to tamp the coffee grinds.
